(19) United States
(12) Patent Application Publication
(10) Pub. No.: US 2016/0116603 A1
(43) Pub. Date: Apr. 28, 2016

(54) METHOD FOR PET ATTENUATION CORRECTION

(71) Applicant: NATIONAL YANG-MING UNIVERSITY, Taipei (TW)

(72) Inventors: Jyh-Cheng CHEN, Taipei (TW); Chia-Lin LAI, Taipei (TW); Jhih-Shian LEE, Taipei (TW)

(21) Appl. No.: 14/684,014

(22) Filed: Apr. 10, 2015

(30) Foreign Application Priority Data
Oct. 23, 2014 (TW) 103136607

(51) Int. Cl. G01T 1/164; G01T 1/16

(52) U.S. Cl. CPC G01T 1/1647; G01T 1/1603

(57) ABSTRACT

The present disclosure illustrates a method for PET attenuation correction, and the method includes the steps: computing linear attenuation coefficients and mean CT numbers of water, various iodine contrasts and a plant oil-based phantom, to generate energy-mapping curve data by ANN; providing an object to be detected, and reconstructing CT data to generate a CT image after the object is scanned by CT and PET respectively; introducing the CT numbers of pixels the CT image into the energy-mapping curve to generate an attenuation map; computing the attenuation map to generate an attenuation correction factor; multiplying the PET image by the attenuation correction factor to generate a corrected PET sinogram, and reconstructing the corrected PET sinogram to generate a corrected PET image.

### CROSS-REFERENCE TO RELATED APPLICATION

This application claims the benefit of Taiwan Patent Application No.103136607, filed on Oct. 23, 2014, the disclosure of which is incorporated herein in its entirety by reference, in the Taiwan Intellectual Property Office.

### BACKGROUND OF THE INVENTION

1. Field of the Invention

The present disclosure relates to an image correction technology, more particularly to a method for attenuation correction applied to a medicine imaging apparatus.

2. Description of the Related Art

The positron emission tomography (PET) is a non-invasive nuclear medicine imaging technology, to provide functional information of metabolism and absorption of the nuclear medicine in different part of human body, and then the qualitative and quantitative analysis are performed according to the functional information. However, a photon signal at 511 keV used in traditional positron emission tomography occurs certain attenuation during transmission in the human body. Such attenuation causes problems of counting-loss and image distortion in an in-vitro detector and the image quality may be impacted seriously and the accuracy of the qualitative and quantitative analysis may be impacted correspondingly. Therefore, attenuation correction is necessary for the PET image.

Before the attenuation correction procedure is processed, each of linear attenuation coefficients corresponding to each of pixels on the image must be acquired in advance, for facilitating to derive an attenuation correction factor (ACF), and then perform the attenuation correction based on the factor. The ACF is defined as ACF=1/e^{-μd}=e^{μd}, and the attenuation relationship of the photon within material is N=N₀×e^{-μd}, where the μ is a linear attenuation coefficient; N is a number of the photon after attenuation; N₀ is an initial number of photon; d is a length of a photon transmission path. ACF is a ratio of the initial number of photon and the number of the photon after attenuation. The attenuation correction factor is multiplied by the original PET sinogram, and then reconstructed to obtain the PET image after attenuation correction.

In the traditional technology, the method for attenuation correction most frequently used in clinical PET/CT is CT-based attenuation correction. In such method, CT numbers of pixels of the CT image scanned at given tube voltage being converted to linear attenuation coefficients at 511 keV to obtain an attenuation map, is a very important step which is called energy-mapping. That is, after the energy-mapping is performed, the attenuation correction factors can be derived from the attenuation map, for performing the attenuation correction.

The energy-mapping method which is most frequently used is called bilinear transformation method, and such method has advantages of simple and quick operation. However, the relationship between CT numbers and linear attenuation coefficients is not simple linear so the transformation accuracy of the bilinear transformation method is not good enough, and it directly affects the subsequent correction for attenuation on the PET image.

### SUMMARY OF THE INVENTION

In order to solve the defects, a main objective of the present disclosure is to provide a method for PET image attenuation correction. In the method, a curve fitting ability of artificial neural network (ANN) is used to derive more accurate energy-mapping, so as to reduce the photon attenuation effect on the PET image and improve the image quality of the PET image, and the PET image can be more valuable in preclinical and clinical diagnoses both.

To achieve the objective, the present disclosure is to provide a method for PET attenuation correction, and the method includes the following steps: computing linear attenuation coefficients and mean CT numbers of water, various iodine contrasts and a plant oil-based phantom; to generate an energy-mapping curve by ANN; scanning the object to be detected by CT and PET respectively to generate a CT sinogram and a PET sinogram; using the CT sinogram to reconstruct a CT image; introducing the CT numbers of pixels on the CT image into the energy-mapping curve to generate an attenuation map; computing the attenuation map to generate an attenuation correction factor; multiplying the PET sinogram by the attenuation correction factor to generate a corrected PET sinogram; reconstructing the corrected PET sinogram to generate a corrected PET image.

### BRIEF DESCRIPTION OF THE DRAWINGS

The detailed structure, operating principle and effects of the present disclosure will now be described in more details hereinafter with reference to the accompanying drawings that show various embodiments of the present disclosure as follows.

FIG. 1 illustrates a comparison table of linear attenuation coefficients of the present disclosure.

FIG. 2 illustrates a comparison table of mean CT numbers of the present disclosure.

FIG. 3 illustrates an energy-mapping curve of the present disclosure.

FIG. 4 illustrates a flow diagram of the method for PET attenuation correction of the present disclosure.

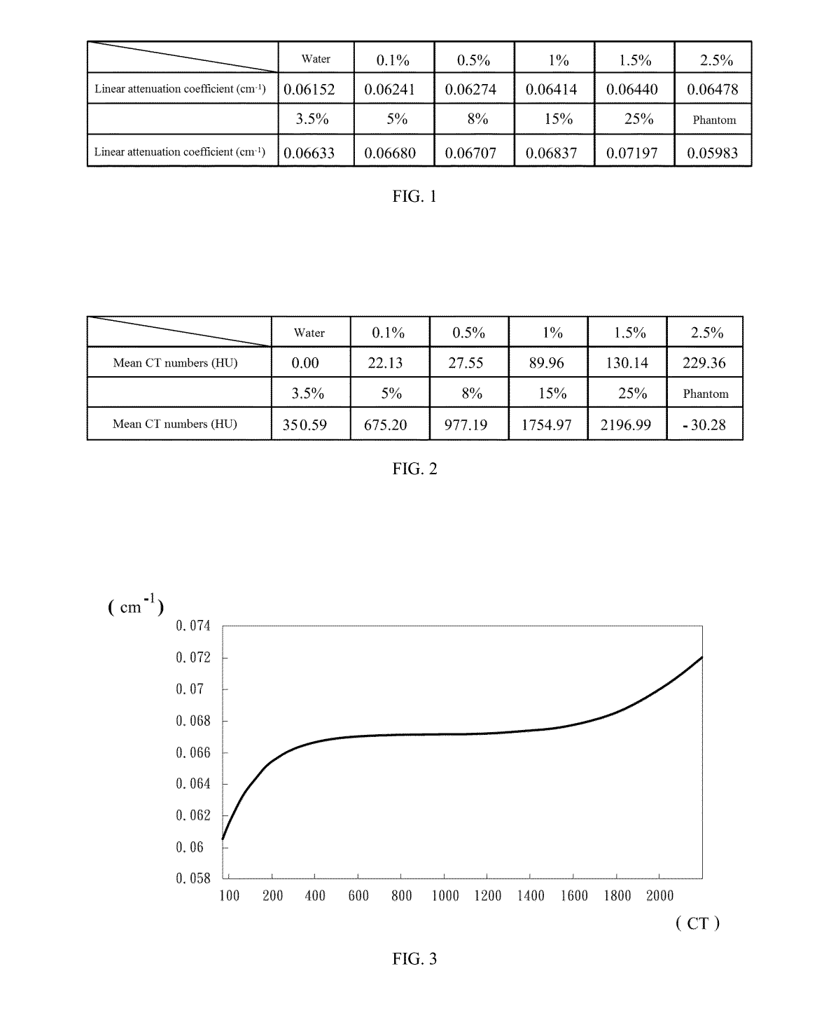

### DETAILED DESCRIPTION OF THE PREFERRED EMBODIMENTS

Reference will now be made in detail to the exemplary embodiments of the present disclosure, examples of which are illustrated in the accompanying drawings. Therefore, it is to be understood that the foregoing is illustrative of exemplary embodiments and is not to be construed as limited to the specific embodiments disclosed, and that modifications to the disclosed exemplary embodiments, as well as other exemplary embodiments, are intended to be included within the scope of the appended claims. These embodiments are provided so that this disclosure will be thorough and complete, and will fully convey the inventive concept to those skilled in the art. The relative proportions and ratios of elements in the drawings may be exaggerated or diminished in size for the sake of clarity and convenience in the drawings, and such arbitrary proportions are only illustrative and not limiting in any way. The same reference numbers are used in the drawings and the description to refer to the same or like parts.

It will be understood that, although the terms ‘first’, ‘second’, ‘third’, etc., may be used herein to describe various elements, these elements should not be limited by these terms. The terms are used only for the purpose of distinguishing one component from another component. Thus, a first element discussed below could be termed a second element without departing from the teachings of embodiments. As used herein, the term “or” includes any and all combinations of one or more of the associated listed items.

The method for attenuation correction of the present disclosure is applied to a PET correction procedure, and will be described in detail according to an implement process of the embodiment.

Before performing operation, each PET apparatus must be performed a complete attenuation correction procedure and a CT-based energy-mapping curve must be acquired first. Next, various different volume concentrations of iodine contrasts and a plant oil-based phantom are provided. Preferably, 10 various volume concentrations of iodine contrasts are provided in this embodiment, as shown in the comparison table of linear attenuation coefficients. The iodine-free water is served as a comparison liquid and listed in this table. The volume concentration of the iodine contrasts are ranging from 0% to 25%. More precisely, the 10 various volume concentration of the iodine contrasts are 0.1%, 0.5%, 1%, 1.5%, 2.5%, 3.5%, 5%, 8%, 15% and 25% respectively. The plant oil-based phantom is defined as the material not applied in human body or live animal. As shown in FIGS. The table includes the linear attenuation coefficients of the water various iodine contrasts and phantom scanned by a PET scanner under a specific condition. In this embodiment. The specific condition of the PET scanner is 511 keV, and these materials are scanned by using Ge-68 transmission source to generate the linear attenuation coefficients corresponding to these materials.

The water, various iodine contrasts and phantom are processed in a CT scan procedure, and scanned on a CT scanner using 50 kVp to generate correspondent CT sinograms, and then the CT image can be reconstructed according to the CT sinograms. Finally, the regions of interest (ROI) are selected and defined on the CT images to compute the mean CT numbers of each of materials under the scanning energy, such as the comparison table of mean CT numbers shown in FIG. 2.

Next, the linear attenuation coefficients and mean CT numbers of the water, various iodine contrasts and phantom, which are generated under different conditions, are computed by ANN to generate an energy-mapping curve, as shown in FIG. 3. In this embodiment, the energy-mapping curve diagram is a curve diagram which represents the CT numbers on the horizontal axis and the linear attenuation coefficient on the vertical axis. Therefore, the energy-mapping procedure is completed.

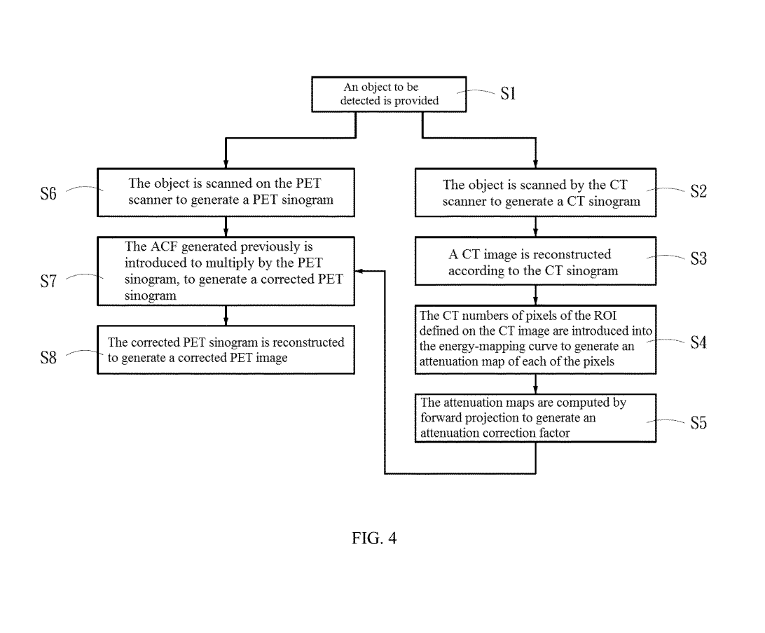

Please refer to FIG. 4 which illustrates a flow diagram of the method for attenuation correction of the present disclosure. As shown in FIG. 4, in step S1 an object to be detected is provided, and in this embodiment the object to be detected s a live animal. In step S2, the object to be detected is scanned by the CT scanner to generate a CT sinogram, and in this embodiment a setting condition of the CT scanner includes tube voltage of 50 kVp, current of 0.2 mA and 120 ms/projection exposure time. In step S3 a CT image is reconstructed according to the CT sinogram. In this embodiment the CT image is reconstructed with Feldkamp-Davis-Kress (FDK) algorithm, and the ROI is selected and defined on the CT image. In step S4, the CT numbers of pixels of the ROI defined on the CT image are introduced into the energy-mapping curve to generate an attenuation map of each of the pixels. Finally, in step S5 the attenuation maps are computed by forward projection to generate an attenuation correction factor (ACF).

Please refer to FIG. 4. As shown in FIG. 4, in step S6 the object to be detected is scanned on the PET scanner again to generate a PET sinogram, and in this embodiment the acquisition time is 900 seconds. In step S7, the ACF generated previously is introduced to multiply by the PET sinogram, to generate a corrected PET sinogram. Finally, in step S8 the corrected PET sinogram is reconstructed to generate a corrected PET image, and the PET attenuation correction is completed. In this embodiment, filtered back-projection (FBP) is used to reconstruct the corrected PET image.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A method for PET attenuation correction, comprising:
a. computing linear attenuation coefficients and mean CT numbers of water, various iodine contrasts and a plant oil-based phantom to generate an energy-mapping curve by ANN;
b. providing an object to be detected, and scanning the object by a CT and a PET;
c. scanning the object to be detected by the CT and the PET respectively to generate a CT sinogram and a PET sinogram;
d. using the CT sinogram to reconstruct a CT image;
e. introducing the CT numbers of pixels on the CT image into the energy-mapping curve to generate an attenuation map;
f. computing the attenuation map to generate an attenuation correction factor;
g. multiplying the PET image by the attenuation correction factor to generate a corrected PET sinogram; and
h. reconstructing the corrected PET sinogram to generate other corrected PET image.

2. The method for PET attenuation correction as defined in claim 1, wherein, in the step a, the various iodine contrasts are different volume concentration of iodine contrasts, and the volume concentrations are ranging from 0% to 25%.

3. The method for PET attenuation correction as defined in claim 1, wherein, in the step a, the various iodine contrasts are different volume concentration of iodine contrasts, and the volume concentrations are 0.1%, 0.5%, 1%, 1.5%, 2.5%, 3.5%, 5%, 8%, 15% and 25%, respectively.

4. The method for PET attenuation correction as defined in claim 1, wherein, in the step a, the linear attenuation coefficients of the water, the various iodine contrasts and the phantom are obtained by a PET scanner at 511 keV.

5. The method for PET attenuation correction as defined in claim 1, wherein, in the step a, the water, the various iodine contrasts and the phantom are scanned on the CT scanner at 50 kVp to generate the corresponding CT sinograms, and the corresponding CT images are reconstructed according to the CT sinograms, and the CT images are computed to generate the mean CT numbers.

6. The method for PET attenuation correction as defined in claim 1, wherein the step d comprises using Feldkamp-Davis-Kress (FDK) algorithm to reconstruct the CT image.

7. The method for PET attenuation correction as defined in claim 1, wherein the step f comprises using forward projection to compute the attenuation map to generate the attenuation correction factor.

8. The method for PET attenuation correction as defined in claim 1, wherein the step h comprises using filtered back-projection to reconstruct the corrected PET sinogram, so as to generate the corrected PET image.
